(19) United States
(12) Patent Application Publication
(10) Pub. No.: US 2026/0366358 A1
(43) Pub. Date: Nov. 19, 2026

(54) SEGMENTED SPACER FOR INSULATED GLASS UNITS

(71) Applicant: SAINT-GOBAIN GLASS FRANCE, COURBEVOIE (FR)

(72) Inventors: Christopher MARJAN, HERZOGENRATH (DE); Walter SCHREIBER, HERZOGENRATH (DE); Nikolai BORCHMANN, HERZOGENRATH (DE)

(21) Appl. No.: 19/487,858

(22) PCT Filed: Apr. 29, 2024
(86) PCT No.: PCT/EP2024/061756

§ 371 Date: Nov. 25, 2025

(30) Foreign Application Priority Data
May 31, 2023 (EP) 23176255.0

(51) Int. Cl. E06B 3/663; E06B 3/673

(52) U.S. Cl. CPC E06B 3/66323; E06B 3/66352; E06B 3/66361; E06B 3/6733

(57) ABSTRACT

A spacer for insulated glass units, includes a main body co-extruded from a first plastics material and a second plastics material, includes a first side wall and a second side wall arranged parallel thereto; a glazing interior wall which connects the side walls to one another; an outer wall which is arranged substantially parallel to the glazing interior wall and connects the side walls to one another directly or via connecting walls; a cavity which is enclosed by the side walls, the glazing interior wall, and the outer wall or by the side walls, the glazing interior wall, the outer wall and the connecting walls; wherein the main body is designed as a hollow profile formed from the first plastics material and the second plastics material and has an alternating arrangement of A and B segments, formed from first and second plastics material respectively.

The invention relates to spacers for insulated glass units, to a method for producing a spacer, to an insulated glass unit, to a method for producing an insulated glass unit, and to the use of the insulated glass unit.

Insulated glass units generally contain at least two panes made from glass or from polymeric materials. The panes are separated from one another by a gas or vacuum space defined by the spacer. The thermal insulation capability of insulating glass is significantly higher than that of single glazing and can be even further increased and improved in triple glazings or with special coatings. For example, silver-containing coatings enable reduced transmission of infrared radiation and thus reduce the cooling of a building in winter.

In addition to the nature and structure of the panes, the other components of an insulated glass unit are also of great importance. The seal and above all the spacer greatly influence the quality of the insulated glass unit.

The thermally insulating properties of insulated glass units are substantially influenced by the thermal conductivity in the region of the edge bond, in particular of the spacer. In the case of metallic spacers, the high thermal conductivity of the metal results in the formation of a thermal bridge at the edge of the pane. On the one hand, this thermal bridge leads to heat losses in the edge region of the insulated glass unit and, on the other hand, with high air humidity and low external temperatures, to the formation of condensate on the inner pane in the region of the spacer. In order to solve these problems, thermally optimized, so-called “warm-edge” systems are increasingly used, in which the spacers consist of materials of lower thermal conductivity, in particular plastics.

From the standpoint of thermal conductivity, polymeric spacers are to be preferred over metallic spacers. However, polymeric spacers have several disadvantages. For one thing, the tightness of polymeric spacers relative to moisture and gas loss is insufficient. In this respect, there are various solutions, in particular by applying a barrier film on the outer side of the spacer (see, for example, WO2013/104507 A1).

On the other hand, the coefficients of linear expansion of plastics are much greater than that of glass. To equalize the coefficients of linear expansion, glass fibers can be mixed in (see EP0852280 A1 and DE 19807454A1 ). However, increased glass fiber content worsens the heat conducting properties of the spacer such that precise optimization must be carried out here. Glass fibers and similar fillers also improve the longitudinal rigidity of the spacer.

Polymeric glass fiber-reinforced spacers are so brittle that, in contrast to metallic spacers, they cannot be cold bent. To produce a spacer frame for an insulated glass unit, multiple pieces of spacer must be connected via plug connectors and glued or welded. Each connection point must be carefully sealed. One approach for increasing bendability is the integration of a metal strip into the polymeric main body (described, for example, in WO2015/043848 A1 and DE19807454 A1). However, the integration of a metallic strip into the polymeric main body during production is very complex.

Polymeric spacers without additional fillers such as glass fibers are flexible and not sufficiently rigid. However, longitudinal rigidity (refers to deflection in the longitudinal direction) is important for machine processability. An improvement in longitudinal rigidity can be achieved through the integration of metallic strips (see previous point) or through external application of metallic elements on the body (see, for example, EP1055046 B2 and EP3241972 A1). However, application of a metallic strip negatively affects the heat conducting properties of the spacer since the metallic elements have increased thermal conductivity. A particular difficulty in the external application of individual metallic elements is the perfect sealing of the edge seal against the penetration of moisture.

In view of the above, the design of a spacer means finding a compromise between mechanical performance and thermal insulation properties since the best performing materials tend to have poor mechanical performance from a thermal point of view, and vice versa.

From WO2021/009176 A1, a combination of different materials with different properties in a spacer produced by co-extrusion is known, wherein the different materials are arranged coaxially in the spacer. In particular, a first plastics material and a second plastics material are used, wherein the second plastics material has a lower thermal conductivity and a higher flexibility than the first plastics material, and the main body of the spacer is designed as a hollow profile formed from the second plastics material, in which hollow profile the first plastics material is arranged at least regionally on the inside directly adjacent to the hollow profile. However, this does not allow for a spacer to be achieved with the lowest possible thermal conductivity since it cannot be ensured that the heat exchange between the inner first plastics material and the panes can be prevented.

DE 10 2011 009 359 A1 discloses a spacer profile with a hollow profile body made from a first plastics material and with a diffusion barrier region made from a second plastics material with sheet silicate that is designed at least as part of the outer wall to form a diffusion barrier. By arranging the diffusion barrier area made of the second plastics material with layered silicate, low thermal conductivity along the outer wall of the spacer cannot be ensured.

In view of the above-described prior art, the present invention is based on the objective of providing an improved spacer which has good mechanical performance and improved thermal insulation properties, as well as being economically viable to produce and environmentally friendly.

The objective of the present invention is achieved according to the invention by a spacer for insulated glass units according to independent claim 1 or 11. Preferred embodiments of the invention are apparent from the dependent claims.

A method for producing the spacers according to the invention, an insulated glass unit according to the invention, a method for producing the insulated glass unit according to the invention, and their use according to the invention are apparent from further independent claims.

The spacer according to the invention for insulated glass units, in accordance with a first aspect, at least comprises a main body co-extruded from a first plastics material and a second plastics material, comprising: a first side wall and a second side wall arranged parallel thereto; a glazing interior wall which connects the side walls to one another; an outer wall which is arranged substantially parallel to the glazing interior wall and connects the side walls to one another directly or via connecting walls; a cavity which is enclosed by the side walls, the glazing interior wall, and the outer wall, or by the side walls, the glazing interior wall, the outer wall and the connecting walls; wherein the main body is designed as a hollow profile formed from the first plastics material and the second plastics material and has an alternating arrangement of A segments and B segments, wherein an A segment is formed from the first plastics material, and a B segment is formed from the second plastics material, and the A and B segments each extend along a longitudinal direction Z of the spacer and abut one another in the longitudinal direction Z, the outer wall comprises a first section that consists of a B segment and is arranged in the center of the outer wall in a transverse direction X of the spacer, which is perpendicular to the longitudinal direction Z of the spacer, and over the entire thickness D1 of the outer wall in a vertical direction Y of the spacer which is perpendicular to the longitudinal direction Z of the spacer, the first side wall comprises a second section that consists of a B segment, the second side wall comprises a third section that consists of a B segment, and the second plastics material has a lower thermal conductivity than the first plastics material.

The first side wall and the second side wall represent the sides of the spacer on which the mounting of the outer panes of an insulated glass unit takes place when the spacer is installed. The first side wall and the second side wall run parallel to one another.

The outer wall of the main body is the wall that is opposite the glazing interior wall and faces away from the interior of the insulated glass unit (inner interpane space) in the direction of the outer interpane space. The outer wall preferably runs substantially perpendicular to the side walls.

The optional first connecting wall and the optional second connecting wall preferably run at an angle a (alpha) of 30° to 60° relative to the outer wall. The angled shape of the first connecting wall and the second connecting wall improves the stability of the main body and enables better bonding and insulation of the spacer according to the invention.

The main body preferably has a width of 5 mm to 80 mm, preferably of 10 mm to 20 mm, along the glazing interior wall. Within the meaning of the invention, the width is the dimension extending between the side walls. The width is the distance between the surfaces of the two side walls that face away from one another. The distance between the panes of the insulated glass unit is determined by the selection of the width of the glazing interior wall. The exact dimensions of the glazing interior wall depend on the dimensions of the insulated glass unit and the desired pane interspace size.

The main body preferably has, along the side walls, a height of 5 mm to 15 mm, particularly preferably of 5 mm to 10 mm. In this height range, the spacer has an advantageous stability but is otherwise advantageously inconspicuous in the insulated glass unit. In addition, the cavity of the spacer has an advantageous size for receiving an appropriate quantity of desiccant. The height of the spacer is the distance between the surfaces of the outer wall and of the glazing interior wall that face away from one another.

The glazing interior wall, the outer wall, the connecting walls, and the side walls are preferably 0.5 mm to 1.5 mm thick, particularly preferably 0.8 mm to 1.0 mm thick. According to one embodiment, the glazing interior wall, the outer wall, the connecting walls and the side walls have a uniform thickness. According to a further embodiment, the glazing interior wall, the outer wall, the connecting walls and/or the side walls have a different thickness. For example, areas of the main body that are exposed to high mechanical stress can have a greater thickness than areas that constitute more thermally relevant areas of the main body. In particular, according to a preferred embodiment, the glazing interior wall and the outer wall have a smaller thickness than the side walls and the connecting walls. The entire thickness of the outer wall of the spacer according to the first aspect is designated D1 according to the invention. “Entire thickness” here means the complete cross-section of the outer wall in the vertical direction Y.

A desiccant can be arranged in the cavity of the spacer. In addition, perforations that establish a connection to the inner interpane space in the insulated glass unit can be made in the glazing interior wall. Desiccant present in the cavity can then absorb moisture from the inner interpane space via the perforations in the glazing interior wall.

According to a preferred embodiment, the desiccant is selected from silica gels, molecular sieves, CaCl₂, Na₂SO₄, activated carbon, silicates, bentonites, zeolites, and/or mixtures thereof. The desiccant can be filled in directly before the assembly of the insulated glass unit. This ensures a particularly high absorption capacity of the desiccant in the finished insulated glass unit. The glazing interior wall preferably has openings/perforations that permit absorption of the atmospheric humidity by the desiccant contained in the main body.

According to the invention, the main body of the spacer is a main body co-extruded from a first plastics material and a second plastics material, i.e., the main body was produced by co-extrusion of a first plastics material with a second plastics material.

The spacer according to the invention has a transverse direction X, a vertical direction Y and a longitudinal direction Z which are each perpendicular to one another. The longitudinal direction Z is the direction of extension of the spacer. According to the invention, the A and B segments each extend along the longitudinal direction Z of the spacer and abut one another in the longitudinal direction Z. The transverse direction X of the spacer runs parallel to the glazing interior wall and the outer wall of the spacer. The vertical direction Y of the spacer runs parallel to the side walls of the spacer.

For the purposes of the invention, an “alternating arrangement” of A segments and B segments means that the A and B segments are arranged alternately along the cavity in the cross-sectional view of the main body. By virtue of this alternating arrangement of A and B segments, good thermal insulation of the spacer can be achieved since at least sectionally along the cavity there is arranged a B segment which is formed from the second plastics material with lower thermal conductivity and which separates areas of the spacer, which have an A segment that is formed from the first plastics material with higher thermal conductivity, from one another.

According to the invention, the A segment is formed from the first plastics material, and the B segment is formed from the second plastics material. In addition, the second plastics material has a lower thermal conductivity than the first plastics material.

Preferably, the second plastics material has a thermal conductivity less by at least 5%, particularly preferably by at least 10%, more preferably by at least 20% than the first plastics material.

According to one embodiment, the second plastics material has a lower stiffness than the first plastics material. Preferably, the second plastics material has a stiffness that is lower by at least 5%, particularly preferably by at least 10%, most preferably by at least 30% than the first plastics material.

By combining two plastics materials having different properties in terms of thermal conductivity and optionally stiffness, specific locations in the main body of the spacer can be designed to be thermally, or thermally and mechanically, optimized.

In a preferred embodiment of the spacer according to the invention, the first plastics material is a glass-fiber-reinforced plastics material, and the second plastics material is a plastics material that has a lower glass fiber content than the first plastics material or is a glass fiber-free plastics material. Preferably, the glass fiber content of the glass-fiber-reinforced plastics material is 10% to 40%, in particular 25% to 40%.

According to one embodiment, the second plastics material is a foamed plastics material, whereby the thermal properties of the spacer can be improved. In a further embodiment of the spacer according to the invention, both the first plastics material and the second plastics material are foamed plastics materials, and the first plastics material is a glass-fiber-reinforced plastics material.

The first plastics material and the second plastics material can be plastics materials based on the same polymer or copolymer. However, it is also possible that the first plastics material and the second plastics material are based on different polymers or copolymers. Preferably, the first plastics material and the second plastics material are based on the same polymers or copolymers. This makes it particularly easy to achieve a stable connection between an A segment and a B segment.

The first plastics material and the second plastics material independently contain, for example, polyethylene (PE), polypropylene (PP), polycarbonate (PC), thermoplastic polyurethane (TPU), polyethylene terephthalate (PET), polybutylene terephthalate (PBT), polymethyl methacrylate (PMMA), PET/PC, PBT/PC, polyamide, polystyrene (PS), styrene-acrylonitrile copolymer (SAN), polymethyl methacrylate, polyacrylate, acrylonitrile-butadiene-styrene copolymer (ABS), acrylonitrile-styrene-acrylate copolymer (ASA), acrylonitrile-butadiene-styrene-polycarbonate (ABS/PC) and/or copolymers or mixtures thereof. Preferably, the first plastics material and the second plastics material independently contain polycarbonate (PC), polymethyl methacrylate (PMMA), polystyrene (PS), styrene-acrylonitrile copolymer (SAN), acrylonitrile-butadiene-styrene copolymer (ABS) and/or copolymers or mixtures thereof.

In one embodiment, the first plastics material is a glass-fiber-reinforced PP, and the second plastics material is a PP that is not glass-fiber-reinforced.

In a preferred embodiment, the first plastics material is a glass-fiber-reinforced SAN, and the second plastics material is a SAN that is not glass-fiber-reinforced.

In another preferred embodiment, the first plastics material is a glass-fiber-reinforced ABS, and the second plastics material is an ABS that is not glass-fiber-reinforced.

In another preferred embodiment, the first plastics material is a glass-fiber-reinforced ABS, and the second plastics material is a TPU that is not glass-fiber-reinforced.

According to the invention, the outer wall comprises a first section which consists of a B segment and is arranged in the center of the outer wall in the transverse direction X of the spacer, and over the entire thickness D1 of the outer wall in the vertical direction Y of the spacer. The arrangement according to the invention of the first section can ensure good thermal insulation along the outer wall. This is particularly advantageous when using the spacer in an insulated glass unit since it can significantly reduce or prevent heat transfer between a first pane and a second pane between which the outer wall is located.

According to the invention, the first section is arranged in the center of the outer wall in the transverse direction X of the spacer. This means that the first section extends symmetrically outwards in both directions from a center line which divides the outer wall into two equal parts when viewed from the hollow profile. “Symmetrical” here means that the two sections of the first section that extend in both directions from the center line are approximately the same length. The symmetrical arrangement of the first section can ensure that when pressure is applied to the spacer, the pressure is evenly distributed, and that no distortion of the shape of the spacer occurs during its production process.

According to one embodiment, the first section extends over at least 20%, preferably at least 30%, more preferably at least 40%, even more preferably at least 45%, of the outer wall in the transverse direction X of the spacer. The higher the percentage of the first section on the outer wall, the stronger the thermal insulation along the outer wall. In one embodiment of the present invention, the first section extends over at most 95%, preferably at most 90%, more preferably at most 80%, even more preferably at most 75%, of the outer wall in the transverse direction X of the spacer. This can ensure that the outer wall has sufficiently high thermal insulation properties. In one embodiment, a total of at least 5%, preferably at least 10%, more preferably at least 20%, even more preferably at least 25%, of the outer wall in the transverse direction X of the spacer has sections that are formed from the first plastics material. According to this embodiment, the outer wall has sufficiently high thermal insulation properties. Preferably, the outer wall comprises two sections which are formed from the first plastics material and between which the first section is arranged.

According to the invention, the first side wall comprises a second section that consists of a B segment. The arrangement according to the invention of the second section can ensure good thermal insulation along the first side wall. This is particularly advantageous when using the spacer in an insulated glass unit since the first side wall is connected to a first pane of the insulated glass unit, and the arrangement of the second section can thus prevent or reduce the heat transfer between the first pane and the spacer.

According to one embodiment, the second section is arranged over the entire thickness of the first side wall so that good thermal insulation properties can be achieved along the first side wall in this area.

In one embodiment of the present invention, the second section extends further to the transition between the first side wall and the first connecting wall. According to a further embodiment, the second section extends further to the transition between the first side wall and the glazing interior wall. These embodiments can allow the spacer to have good thermal insulation properties in this area.

According to a further embodiment, the first side wall consists of the second section, whereby the best possible thermal insulation can be achieved along the entire contact surface with the first pane.

According to the invention, the second side wall comprises a third section that consist of a B segment. The arrangement according to the invention of the third section can ensure good thermal insulation along the second side wall. This is particularly advantageous when using the spacer in an insulated glass unit since the second side wall is connected to a second pane of the insulated glass unit, and the arrangement of the third section can hereby prevent or reduce heat transfer between the second pane and the spacer.

According to one embodiment, the third section is arranged over the entire thickness of the second side wall so that good thermal insulation properties can be achieved along the second side wall in this area.

In one embodiment of the present invention, the third section extends further to the transition of the second side wall and the second connecting wall. According to a further embodiment, the third section extends further to the transition between the second side wall and the glazing interior wall. These embodiments allow the spacer to have good thermal insulation properties in this area.

According to a further embodiment, the second side wall consists of the third section, whereby the best possible thermal insulation can be achieved along the entire contact surface with the second pane.

In one embodiment of the invention, the glazing interior wall comprises a fourth section that consists of a B segment. By using the fourth section, good thermal insulation can be ensured along the glazing interior wall. This is particularly advantageous when using the spacer in an insulated glass unit, as it can significantly reduce or prevent heat transfer between a first pane and a second pane, between which the glazing interior wall is located.

According to one embodiment of the invention, the fourth section is arranged in the center of the glazing interior wall in the transverse direction X of the spacer. This means that the fourth section extends symmetrically outwards in both directions from a center line which divides the glazing interior wall into two equal size parts when viewed from the hollow profile. “Symmetrical” here means that the two sections of the fourth section, that extend in both directions from the center line, are approximately the same length. The symmetrical arrangement of the fourth section ensures that when pressure is applied to the spacer, the pressure is evenly distributed and that there is no distortion of the shape of the spacer during its production process.

According to one embodiment, the fourth section extends over at least 20%, preferably at least 30%, more preferably at least 40%, even more preferably at least 45%, of the glazing interior wall in the transverse direction X of the spacer. The higher the percentage of the fourth section on the glazing interior wall, the stronger the thermal insulation along the glazing interior wall. In one embodiment of the present invention, the fourth section extends over at most 95%, preferably at most 90%, more preferably at most 80%, even more preferably at most 75%, of the glazing interior wall in the transverse direction X of the spacer. This can ensure that the glazing interior wall has sufficiently high thermal insulation properties. In one embodiment, a total of at least 5%, preferably at least 10%, more preferably at least 20%, even more preferably at least 25%, of the glazing interior wall in the transverse direction X of the spacer has sections formed from the first plastics material. According to this embodiment, the glazing interior wall has sufficiently high thermal insulation properties. Preferably, the glazing interior wall comprises two sections which are formed from the first plastics material and between which the fourth section is arranged.

According to one embodiment, the fourth section is arranged over the entire thickness of the glazing interior wall so that good thermal insulation properties can be achieved along the glazing interior wall in this area.

In one embodiment, the transition between the first side wall and the outer wall or the transition between the first connecting wall and the outer wall comprises a fifth section that consists of an A segment. Preferably, the fifth section extends, starting from the transition, into the first side wall and into the outer wall or into the first connecting wall and into the outer wall. This allows forces that act due to a load in the area of the fifth section to be distributed even better.

According to one embodiment, the transition between the second side wall and the outer wall or the transition between the second connecting wall and the outer wall comprises a sixth section that consists of an A segment. Preferably, the sixth section extends, starting from the transition, into the second side wall and into the outer wall or into the second connecting wall and into the outer wall. This allows forces that act due to a load in the area of the sixth section to be distributed even better.

In one embodiment, the transition between the first side wall and the glazing interior wall comprises a seventh section that consists of an A segment. Preferably, the seventh section extends, starting from the transition, into the first side wall and into the glazing interior wall. This allows forces that act due to a load in the area of the seventh section to be distributed even better.

According to one embodiment of the invention, the transition between the second side wall and the glazing interior wall comprises an eighth section that consists of an A segment. Preferably, the eighth section extends, starting from the transition, into the second side wall and into the glazing interior wall. This allows forces that act due to a load in the area of the eighth section to be distributed even better.

In one embodiment, the main body comprises at least eight sections, preferably exactly eight sections. Due to the presence of a plurality of sections, the properties of the spacer can be particularly well adjusted, particularly with regard to thermal insulation and, if necessary, mechanical performance. Preferably, the main body consists of four A segments and four B segments.

According to one embodiment, the main body further comprises at least one section on the inside and/or outside of the cavity, which section is formed from the first plastics material and/or the second plastics material. For example, a layer that is formed from the second plastics material can be arranged on the entire surface of the glazing interior wall on the outside of the cavity. This layer can be perceived by the observer when the spacer is installed in an insulated glass unit. By using a glass-fiber-free plastics material, for example, as a second plastics material, a smooth surface can be obtained that has a high gloss effect. Alternatively or additionally, the second plastics material may comprise a pigment that colors the second plastics material. By using such a colored second plastics material in the layer, the spacer can be perceived as colored by the outside observer without the entire spacer having to contain pigments, which makes the spacer more cost-effective and environmentally friendly overall. If the above-mentioned layer is used, the first plastics material and the second plastics material from which the main body is formed apart from the layer do not have to meet high optical requirements since they are not visible from the outside so that the first plastics material and the second plastics material for the main body apart from the layer can independently contain a recycled material or consist of a recycled material. According to a further embodiment, the entire main body has a layer that is formed from the second plastics material on the outside of the cavity. This allows the thermal insulation of the spacer to be further improved. Alternatively or additionally, the entire main body may further have a layer that is formed from the first plastics material on the inside of the cavity.

In one embodiment, the spacer has a barrier film. The barrier film is preferably arranged on the outer wall, the optional first connecting wall, and the optional second connecting wall, and at least on a part of the side walls. The barrier film can, for example, be attached to the main body with an adhesive. The barrier film comprises, for example, a metal-containing barrier layer of 7-μm-thick aluminum, a polymeric layer of 12-μm-thick polyethylene terephthalate (PET), and a metal-containing thin layer of 10-nm-thick aluminum. Polyethylene terephthalate is particularly suitable for protecting the 7-μm-thick aluminum layer against mechanical damage, since PET films are characterized by particularly high tear resistance. The film layers are, for example, arranged such that the aluminum layers, i.e., the metal-containing barrier layer and the metal-containing thin layer, are on the outside. The film is preferably arranged on a main body such that the metal-containing barrier layer faces the outer wall. Then, the metal-containing thin layer faces outward and simultaneously acts as an adhesive layer with respect to the material of the secondary sealant. Thus, the metal-containing thin layer has not only a barrier effect but also has the function of an adhesion promoter. The barrier film can comprise a foamed polymer layer to further improve the thermal properties.

The spacer according to the invention for insulated glass units, in accordance with a second aspect, at least comprises a main body co-extruded from a first plastics material and a second plastics material, comprising a first side wall and a second side wall arranged parallel thereto, a glazing interior wall which connects the side walls to one another, wherein the glazing interior wall has a recess running substantially parallel to the side walls for receiving a pane, an outer wall which is arranged substantially parallel to the glazing interior wall and connects the side walls to one another directly or via connecting walls, cavities which are enclosed by the first side wall and the second side wall, respectively, the glazing interior wall, the outer wall and the recess, or by the first side wall and the second side wall, respectively, the glazing interior wall, the outer wall, the first connecting wall and the second connecting wall, respectively, and the recess, wherein the main body is designed as a hollow profile formed from the first plastics material and the second plastics material and which has an alternating arrangement of A segments and B segments, wherein an A segment is formed from the first plastics material and a B segment is formed from the second plastics material, and the A and B segments each extend along a longitudinal direction Z of the spacer and abut one another in the longitudinal direction Z, the outer wall comprises two first sections which each consist of a B segment and are arranged in the center between the first side wall and the second side wall, respectively, and the recess in a transverse direction X of the spacer, which is perpendicular to the longitudinal direction Z of the spacer, and over the entire thickness D2 of the outer wall in a vertical direction Y of the spacer, which is perpendicular to the longitudinal direction Z of the spacer, the first side wall comprises a second section that consists of a B segment, the second side wall comprises a third section that consists of a B segment, and the second plastics material has a lower thermal conductivity than the first plastics material.

The embodiments and definitions described above in connection with the spacer according to the invention in accordance with the first aspect also apply in the same way to the spacer according to the invention in accordance with the second aspect, unless different information is explicitly given for the spacer according to the invention in accordance with the second aspect.

The main body of the spacer in accordance with the second aspect preferably has a width of 5 mm to 80 mm, preferably of 10 mm to 35 mm, along the glazing interior wall.

The entire thickness of the outer wall of the spacer according to the second aspect is designated D2 according to the invention. “Entire thickness” here means the complete cross-section of the outer wall in the vertical direction Y.

According to the invention, the outer wall of the spacer according to the second aspect comprises two first sections, which each consist of a B segment and are arranged in the center between the first side wall and the second side wall, respectively, and the recess in the transverse direction X of the spacer, and over the entire thickness D2 of the outer wall in the vertical direction Y of the spacer. The arrangement according to the invention of the first sections can ensure good thermal insulation along the outer wall. This is particularly advantageous when using the spacer in an insulated glass unit since it can significantly reduce or prevent heat transfer between a first pane and a second pane between which the outer wall is located.

According to the invention, the first sections are arranged in the center between the first side wall and the second side wall, respectively, and the recess in the transverse direction X of the spacer in accordance with the second aspect. This means that a first section extends symmetrically outwards in both directions from a center line which divides the outer wall into two equal parts between the first and second side wall, respectively, and the recess when viewed from the hollow profile. “Symmetrical” here means that the two sections of the respective first section, which extend in both directions from the center line, are approximately the same length. The symmetrical arrangement of the first section can ensure that when pressure is applied to the spacer, the pressure is evenly distributed, and that there is no distortion of the shape of the spacer during its production process.

A desiccant can be arranged in each of the cavities of the spacer according to the second aspect. In addition, perforations that establish a connection to the inner interpane space in the insulated glass unit can be made in the glazing interior wall. Desiccant present in the cavities can then absorb moisture from the inner interpane space via the perforations in the glazing interior wall.

According to the invention, the main body of the spacer according to the second aspect has a recess. This recess runs substantially parallel to the side walls and is suitable for receiving a pane. The bottom of the recess is preferably formed by the outer wall. As a result, the greatest possible depth of the recess is obtained and the area of the side flanks of the recess for stabilizing the pane accommodated in the recess is maximized. According to an alternative embodiment, the bottom of the recess does not abut the outer wall, and both cavities extend below the recess.

The invention further comprises a method for producing a spacer according to the invention, wherein at least:
(a) a first nozzle is provided for the extrusion of the first plastics material;
(b) a second nozzle is provided for the extrusion of the second plastics material; and
(c) the first plastics material and the second plastics material are co-extruded to form the main body in such a way that this main body is designed as the hollow profile formed from the first plastics material and the second plastics material, and which has the alternating arrangement of A segments and B segments.

Step (b) can also be performed before step (a).

The first nozzle and the second nozzle are not particularly restricted. Conventional nozzles for extruding plastics materials, which are known to a person skilled in the art, can be used.

The invention further comprises an insulated glass unit that at least comprises a first pane, a second pane, a spacer according to the invention arranged peripherally between the first pane and the second pane, wherein the first pane is attached to the first side wall by means of a primary sealant, the second pane is attached to the second side wall by means of a primary sealant, the spacer separates an inner pane interspace from an outer pane interspace, and a secondary sealant is arranged in the outer pane interspace.

This means that a primary sealant is arranged between the first side wall and the first pane and between the second side wall and the second pane. The primary sealant makes contact with the side walls or with a barrier film, which can optionally be attached to the side walls, the optional connecting walls, and the outer wall of the main body. The first pane and the second pane are arranged parallel and preferably congruently. The edges of the two panes are therefore arranged flush in the edge region, i.e., they are located at the same height. The inner pane interspace is delimited by the first and second panes and the glazing interior wall. The outer interpane space is defined as the space that is delimited by the first pane, the second pane, and the optional barrier film on the outer wall, or the outer wall of the main body. The outer pane interspace is at least partially filled with a secondary sealant. The secondary sealant contributes to the mechanical stability of the insulated glass unit and absorbs a portion of the climate stresses that act on the edge bond.

In a preferred embodiment of the insulated glass unit according to the invention, if a barrier film is present, the primary sealant extends all the way to the regions of the first and second side wall adjacent to the glazing interior wall, which regions are free of the barrier film. Thus, the primary sealant covers the transition between the main body and the barrier film such that a particularly good seal of the insulated glass unit is achieved. In this way, the diffusion of moisture into the cavity of the spacer is reduced at the location where the barrier film is adjacent to the plastic (less interface diffusion).

In a further preferred embodiment of the insulated glass unit according to the invention, the secondary sealant is applied along the first pane and the second pane such that a central region of the outer wall is free of secondary sealant. The central region denotes the region arranged centrally in relation to the two outer panes, in contrast to the two outer regions of the outer wall, which are adjacent to the first pane and the second pane. In this way, good stabilization of the insulated glass unit is achieved, wherein material costs for the secondary sealant are saved at the same time. At the same time, this arrangement can be easily produced by applying two strands of secondary sealant to the outer wall in the outer region adjacent to the outer panes.

In a further preferred embodiment, the secondary sealant is applied such that the entire outer interpane space is completely filled with secondary sealant. This leads to maximum stabilization of the insulated glass unit.

The secondary sealant preferably contains polymers or silane-modified polymers, particularly preferably organic polysulfides, silicones, room-temperature cross-linking (RTV) silicone rubber, peroxide-crosslinked silicone rubber and/or addition-crosslinked silicone rubber, polyurethanes and/or butyl rubber. These sealants have a particularly good stabilizing effect.

The primary sealant preferably contains a polyisobutylene. The polyisobutylene may be a crosslinking or non-crosslinking polyisobutylene.

The first pane and the second pane of the insulated glass unit preferably contain glass, ceramic and/or polymers, particularly preferably quartz glass, borosilicate glass, soda-lime glass, polymethyl methacrylate or polycarbonate.

According to one embodiment, the first pane and the second pane each have a thickness of 2 mm to 50 mm, preferably of 3 mm to 16 mm, wherein the two panes may also have different thicknesses.

In a preferred embodiment of the insulated glass unit according to the invention, the spacer frame consists of one or more spacers according to the invention. For example, it may be a spacer according to the invention which is bent to form a complete frame. It may also be a plurality of spacers according to the invention which are linked to one another via one or more plug connectors. The plug connectors may be designed as longitudinal connectors or corner connectors. Such corner connectors may be designed, for example, as a plastic molded part with a seal, in which two spacers provided with a miter cut abut.

In principle, a wide variety of geometries of the insulated glass unit are possible, e.g., rectangular, trapezoidal and rounded shapes. In order to produce round geometries, the spacer according to the invention may, for example, be bent in the heated state.

In a further embodiment, the insulated glass unit comprises more than two panes. In this case, the spacer can contain, for example, recesses in which at least one further pane is arranged. A plurality of panes could also be formed as a laminated glass pane.

The invention further comprises a method for producing an insulated glass unit according to the invention, wherein at least
(a) a spacer according to the invention is provided;
(b) the spacer is assembled to form a spacer frame;
(c) a first pane and a second pane are provided;
(d) the spacer is fastened between the first pane and the second pane by means of a primary sealant;
(e) the pane arrangement composed of the panes and the spacer is compressed; and
(f) the outer pane interspace is at least partially filled with a secondary sealant.

The insulation glass unit is produced automatically in double-glazing systems known to the person skilled in the art. First, a spacer frame comprising the spacer according to the invention is provided. For example, the spacer frame is produced by welding, gluing and/or by means of a plug connector. A first pane and a second pane are provided, and the spacer frame is fixed between the first and the second pane by means of a primary sealant. The spacer frame is placed with the first side wall of the spacer onto the first pane and fastened by means of the primary sealant. The second pane is then placed congruently with the first pane onto the second side wall of the spacer and likewise fastened by means of the primary sealant, and the pane arrangement is compressed. The outer pane interspace is at least partially filled with a secondary sealant. The method according to the invention thus enables the simple and cost-effective production of an insulation glass unit. No special new machines are required, since, thanks to the design of the spacer according to the invention, conventional machines as are already available for spacers known from the prior art can be used.

The first pane and the second pane may also be provided before the spacer frame is provided.

As described above, when the spacer frame is provided, the main body of the spacer is manufactured by co-extrusion of a first plastics material with a second plastics material.

The invention furthermore comprises the use of the insulated glass unit according to the invention as building interior glazing, building exterior glazing and/or facade glazing.

The various embodiments of the invention can be implemented individually or in any combinations. In particular, the features mentioned above and explained below can be used not only in the specified combinations but also in other combinations or alone without departing from the scope of the present invention.

In the following, the invention is explained in more detail with the aid of drawings and examples of embodiments. The drawings are schematic representations and are not true to scale. The drawings do not limit the invention in any way.

### IN THE DRAWINGS

FIG. 1 shows a cross-section of an embodiment of a spacer I according to the invention,

FIG. 2 shows a cross-section of another embodiment of a spacer I according to the invention,

FIG. 3 shows a cross-section of another embodiment of a spacer I according to the invention,

FIG. 4 shows a cross-section of another embodiment of a spacer I according to the invention,

FIG. 5 shows a cross-section of an embodiment of a spacer II according to the invention,

FIG. 6 shows a perspective view of a cross-section of an embodiment of a spacer I according to the invention,

FIG. 7 shows a cross-section of an embodiment of an insulated glass unit III according to the invention, and

FIG. 8 shows a flowchart of the method according to the invention.

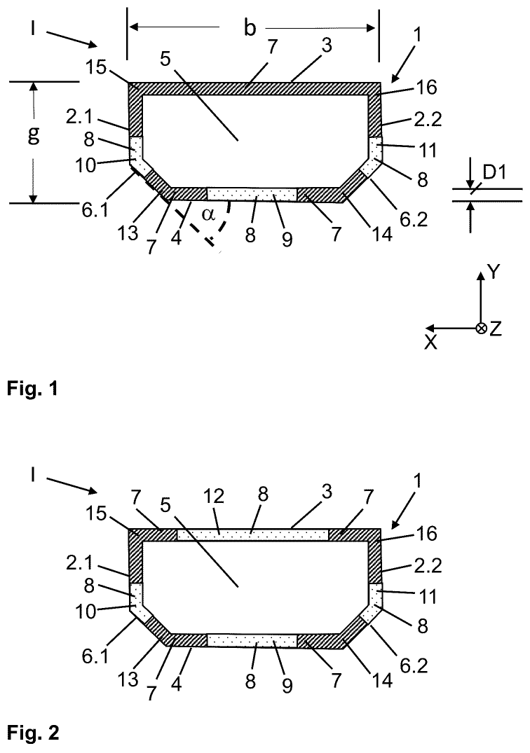

FIG. 1 shows a cross-section of an embodiment of a spacer I according to the invention. In the embodiment shown in FIG. 1, the spacer I comprises a main body 1 formed from a first side wall 2.1, a second side wall 2.2 arranged parallel thereto, a glazing interior wall 3, an outer wall 4, a first connecting wall 6.1, a second connecting wall 6.2, and a cavity 5. The first side wall 2.1 and the second side wall 2.2 are connected to one another via the glazing interior wall 3. The outer wall 4 is arranged substantially parallel to the glazing interior wall 3 and is connected to the first side wall 2.1 via the first connecting wall 6.1 and to the second side wall 2.2 via the second connecting wall 6.2. The first connecting wall 6.1 and the second connecting wall 6.2 are optional; alternatively, the first side wall 2.1 and the second side wall 2.2 can also be directly connected to the outer wall 4. The cavity 5 is enclosed by the first side wall 2.1, the glazing interior wall 3, the second side wall 2.2, the first connecting wall 6.1, the second connecting wall 6.2, and the outer wall 4. The connecting walls 6.1, 6.2 preferably run at an angle a (alpha) of 30° to 60° relative to the outer wall 4. The angled shape of the first connecting wall 6.1 and the second connecting wall 6.2 improves the stability of the main body and enables better bonding and insulation of the spacer I according to the invention.

The main body 1 is designed as a hollow profile that is formed from a first plastics material 7 and a second plastics material 8 and has an alternating arrangement of A segments and B segments, wherein an A segment is formed from the first plastics material 7 and a B segment is formed from the second plastics material 8, and the A and B segments each extend along a longitudinal direction Z of the spacer I and abut one another in the longitudinal direction Z.

The outer wall 4 comprises a first section 9 which consists of a B segment and is arranged in the center of the outer wall 4 in the transverse direction X of the spacer I and over the entire thickness D1 of the outer wall 4 in a vertical direction Y of the spacer I.

The first side wall 2.1 comprises a second section 10 that consists of a B segment, and the second side wall 2.2 comprises a third section 11 that consists of a B segment.

The transition between the first connecting wall 6.1 and the outer wall 4 comprises a fifth section 13 that consists of an A segment, and the transition between the second connecting wall 6.2 and the outer wall 4 comprises a sixth section 14 that consists of an A segment.

The transition between the side wall 2.1 and the glazing interior wall 3 comprises a seventh section 15 consisting of an A segment, and the transition between the side wall 2.2 and the glazing interior wall 3 comprises an eighth section 16 that consists of an A segment. The seventh section 15 and the eighth section 16 are connected via the glazing interior wall 3 which consists of an A segment. This means that an A segment extends in one piece along the entire glazing interior wall 3 and comprises the seventh section 15 and the eighth section 16.

The wall thickness of the main body 1 is, for example, 1 mm. The wall thickness also corresponds to the thickness D1 in this embodiment. The width b of the main body 1 along the glazing interior surface 3 is, for example, 12 mm. The total height g of the main body 1 is, for example, 6.5 mm.

The first plastics material 7 is, for example, an acrylonitrile-butadiene-styrene copolymer (ABS) with a glass fiber content of 40%, and the second plastics material 8 is, for example, the same acrylonitrile-butadiene-styrene copolymer (ABS) which, however, does not contain any glass fibers.

The cavity 5 can accommodate a desiccant (not shown in FIG. 1). Perforations (not shown in FIG. 1) that establish a connection to the inner interpane space in the insulated glass unit can be made in the glazing interior wall 3. The desiccant can then absorb moisture from the inner pane interspace via the perforations in the glazing interior wall 3.

The main body 1 of the embodiment shown in FIG. 1 of a spacer I according to the invention is produced by co-extrusion of the first plastics material 7 and the second plastics material 8.

FIG. 2 shows a cross-section of another embodiment of a spacer I according to the invention. The embodiment shown in FIG. 2 differs from that shown in FIG. 1 only in that the glazing interior wall 3 comprises a fourth section 12 that consists of a B segment.

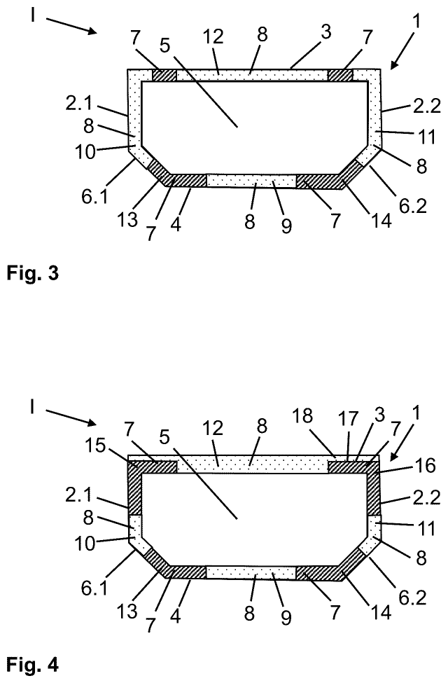

FIG. 3 shows a cross-section of another embodiment of a spacer I according to the invention. The embodiment shown in FIG. 3 differs from that shown in FIG. 2 only in that the transition between the side wall 2.1 and the glazing interior wall 3 does not comprise a seventh section 15 that consists of an A segment, and the transition between the side wall 2.2 and the glazing interior wall 3 does not comprise an eighth section 16 that consists of an A segment. Instead, the second section 10 extends further to the transition between the side wall 2.1 and the glazing interior wall 3, and the third section 11 extends further to the transition between the side wall 2.2 and the glazing interior wall 3. The side wall 2.1 consists of the second section 10, and the side wall 2.2 consists of the third section 11.

FIG. 4 shows a cross-section of another embodiment of a spacer I according to the invention. The embodiment shown in FIG. 4 differs from that shown in FIG. 2 only in that a layer 18 that is formed from the second plastics material 8 is arranged on the entire surface 17 of the glazing interior wall 3 on the outside of the cavity 5.

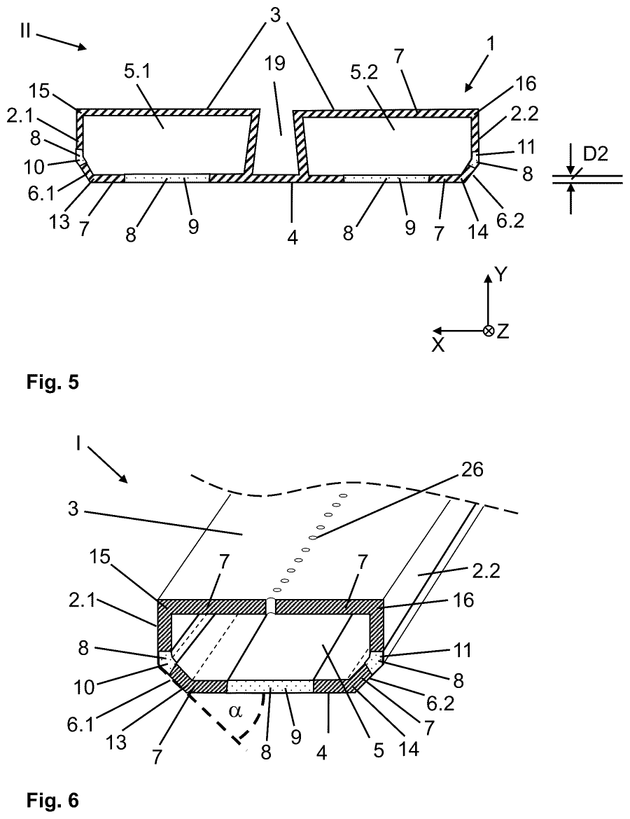

FIG. 5 shows a cross-section of an embodiment of a spacer II according to the invention. The spacer II shown in FIG. 5 substantially corresponds to the spacer I shown in FIG. 1, but the main body 1 in the glazing interior wall 3 has a recess 19 running substantially parallel to the side walls 2.1 and 2.2 for receiving a pane and two cavities 5.1 and 5.2. The bottom of the recess 19 is formed by the outer wall 4 in the embodiment. However, it is also possible for the bottom of the recess 19 not to abut the outer wall 4 and for both cavities 5.1 and 5.2 to extend below the recess 19.

The wall thickness of the main body 1 is, for example, 1 mm. The wall thickness also corresponds to the thickness D2 in this embodiment. The width b of the main body 1 along the glazing interior surface 3 is, for example, 25 mm. The total height g of the main body 1 is, for example, 6.5 mm.

The cavities 5.1 and 5.2 can each receive a desiccant (not shown in FIG. 5). Perforations (not shown in FIG. 5) that establish a connection to the inner interpane spaces in the insulated glass unit can be made in the glazing interior wall 3. The desiccant can then absorb moisture from the inner interpane spaces via the perforations in the glazing interior wall 3.

The main body 1 of the embodiment of a spacer II according to the invention shown in FIG. 5 is produced by co-extrusion of the first plastics material 7 and the second plastics material 8.

FIG. 6 shows a perspective view of a cross-section of an embodiment of a spacer I according to the invention. The spacer I depicted in FIG. 6 corresponds to the spacer I shown in FIG. 1. Due to the perspective view, the perforations 26 can be seen in the glazing interior wall 3 in FIG. 6.

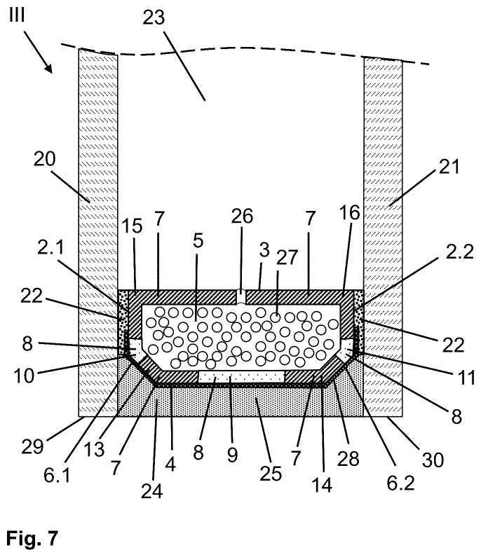

FIG. 7 shows a cross-section of the insulated glass unit III according to the invention with a spacer I arranged between a first pane 20 and a second pane 21, which spacer substantially corresponds to that described in FIG. 1, wherein the spacer I used in the insulated glass unit III in FIG. 7 has a barrier film 28. The barrier film 28 is arranged on the outer wall 4, the first connecting wall 6.1, and the second connecting wall 6.2 and on a part of the side walls 2.1 and 2.2. The first pane 20, the second pane 21, and the barrier film 28 delimit the outer interpane space 24 of the insulated glass unit III. The edge 29 of the first pane 20 and the edge 30 of the second pane 21 are arranged at the same height. The secondary sealant 25, which contains, for example, a silicone, is arranged in the outer interpane space 24. Silicones absorb the forces acting on the edge bond particularly well and thus contribute to high stability of the insulated glass unit III. The barrier film 28, together with the secondary sealant 25, insulates the inner interpane space 23 and reduces heat transfer from the main body 1 into the inner interpane space 23. The barrier film 28 can, for example, be attached to the main body 1 with PUR hot melt adhesive. A primary sealant 22 is preferably arranged between the side walls 2.1 and 2.2 and the panes 20, 21. This contains, for example, butyl. The primary sealant 22 overlaps the barrier film 28 to prevent possible interfacial diffusion. The first pane 20 and the second pane 21 preferably have the same dimensions and thicknesses. The panes preferably have an optical transparency of >85%. The panes 20, 21 preferably contain glass and/or polymers, preferably flat glass, float glass, quartz glass, borosilicate glass, soda lime glass, polymethyl methacrylate, and/or mixtures thereof. The first pane 20 and the second pane 21 are, for example, 3 mm thick. In an alternative embodiment, the first pane 20 and/or the second pane 21 can be designed as a composite glass pane. A desiccant 27, for example molecular sieve, is arranged within the cavity 5 of the main body 1. This desiccant 27 can be filled into the cavity 5 of the spacer I prior to assembly of the insulated glass unit III. The glazing interior wall 3 comprises perforations 26 that enable gas exchange with the inner interpane space 23.

The barrier film 28 comprises, for example, a metal-containing barrier layer of 7 μm-thick aluminum, a polymeric layer of 12 μm-thick polyethylene terephthalate (PET), and a metal-containing thin layer of 10 nm-thick aluminum. Polyethylene terephthalate is particularly suitable for protecting the 7-μm-thick aluminum layer against mechanical damage, since PET films are characterized by particularly high tear resistance. The film layers are, for example, arranged such that the aluminum layers, i.e., the metal-containing barrier layer and the metal-containing thin layer, are on the outside. The film is arranged on the main body 1 such that the metal-containing barrier layer faces the outer wall 4. Then, the metal-containing thin layer faces outward and simultaneously acts as an adhesive layer with respect to the material of the secondary sealant. Thus, the metal-containing thin layer has not only a barrier effect but also has the function of an adhesion promoter.

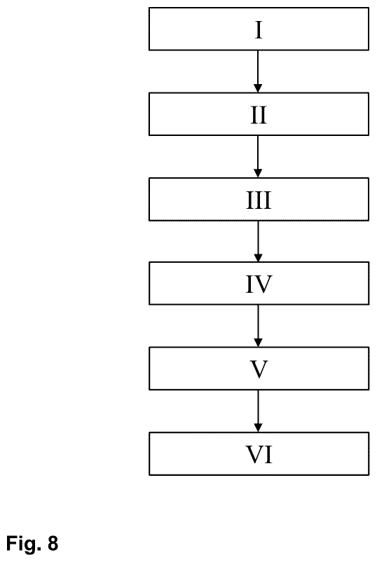

FIG. 8 depicts the flow chart of a method according to the invention for producing an insulated glass unit III according to the invention. In a first step I, a spacer I or II according to the invention is provided. In a second step II, the spacer I or II is joined together to form a spacer frame. In a third step III, a first pane 20 and a second pane 21 are provided. Alternatively, the third step III may also take place before the first step I. In a fourth step IV, the spacer I or II is fastened between the first pane 20 and the second pane 21 by means of a primary sealant 22. In a fifth step V, the pane arrangement of the panes 20, 21 and the spacer I or II is compressed in an insulation glass press. In a sixth step VI, the outer pane interspace 24 is at least partially filled with a secondary sealant 25.

### LIST OF REFERENCE SIGNS

I Spacer
II Spacer
III Insulated glass unit
1 Main body
2.1 First side wall
2.2 Second side wall
3 Glazing interior wall
4 Outer wall
5 Cavity
5.1 Cavity
5.2 Cavity
6.1 First connecting wall
6.2 Second connecting wall
7 First plastics material
8 Second plastics material
9 First section
10 Second section
11 Third section
12 Fourth section
13 Fifth section
14 Sixth section
15 Seventh section
16 Eighth section
17 Surface
18 Layer
19 Recess
20 First pane
21 Second pane
22 Primary sealant
23 Inner pane interspace
24 Outer pane interspace
25 Secondary sealant
26 Perforation in the glazing interior wall
27 Desiccant
28 Barrier film
29 Edge of the first pane
30 Edge of the second pane
X Transverse direction
Y Vertical direction
Z Longitudinal direction
D1 Entire thickness of the outer wall
D2 Entire thickness of the outer wall
b Width of the polymeric main body along the glazing interior surface
g Total height of the main body along the pane contact surfaces

1. A spacer for insulated glass units, comprising:
a main body co-extruded from a first plastics material and a second plastics material, comprising:
a first side wall and a second side wall arranged parallel thereto,
a glazing interior wall which connects the first and second side walls to one another;
an outer wall which is arranged substantially parallel to the glazing interior wall and connects the first and second side walls to one another directly or via connecting walls;
a cavity which is enclosed by the first and second side walls the glazing interior wall and the outer wall, or by the first and second side walls, the glazing interior wall, the outer wall and the connecting walls,
wherein
the main body is designed as a hollow profile which is formed from the first plastics material and the second plastics material and which has an alternating arrangement of A segments and B segments, wherein an A segment is formed from the first plastics material and a B segment is formed from the second plastics material and the A and B segments each extend along a longitudinal direction of the spacer and abut one another in the longitudinal direction
the outer wall comprises a first section which consists of a B segment and is arranged in a center of the outer wall in a transverse direction of the spacer, which is perpendicular to the longitudinal direction of the spacer, and over the entire thickness of the outer wall in a vertical direction of the spacer which is perpendicular to the longitudinal direction of the spacer,
the first side wall comprises a second section that consists of a B segment,
the second side wall comprises a third section that consists of a B segment, and
the second plastics material has a lower thermal conductivity than the first plastics material.

2. The spacer according to claim 1, wherein the glazing interior wall comprises a fourth section that consists of a B segment.

3. The spacer according to claim 1, wherein a transition between the first side wall and the outer wall or a transition between a first connecting wall and the outer wall comprises a fifth section that consists of an A segment, and
a transition between the second side wall and the outer wall or a transition between a second connecting wall and the outer wall comprises a sixth section that consists of an A segment.

4. The spacer according to claim 1, wherein a transition between the first side wall and the glazing interior wall comprises a seventh section that consists of an A segment, and
a transition between the second side wall and the glazing interior wall comprises an eighth section that consists of an A segment.

5. The spacer according to claim 1, wherein the second section extends further to a transition between the first side wall and the glazing interior wall, and
the third section extends further to a transition between the second side wall and the glazing interior wall.

6. The spacer according to claim 1, wherein the second section extends further to a transition between the first side wall and a first connecting wall, and
the third section extends further to the a transition between the second side wall and a second connecting wall.

7. The spacer according to claim 1, wherein the first side wall consists of the second section, and
the second side wall consists of the third section.

8. The spacer according to claim 1, wherein a layer that is formed from the second plastics material is arranged on the entire surface of the glazing interior wall on the outside of the cavity.

9. The spacer according to claim 1, wherein the first plastics material is a glass fiber-reinforced plastics material, and the second plastics material has a lower glass fiber content than the first plastics material or is a glass fiber-free plastics material.

10. The spacer according to claim 1, wherein the second plastics material is a foamed plastics material.

11. A spacer for insulated glass units, comprising:
a main body co-extruded from a first plastics material and a second plastics material, comprising
a first side wall and a second side wall arranged parallel thereto,
a glazing interior wall which connects the first and second side walls to one another, wherein the glazing interior wall has a recess running substantially parallel to the first and second side walls for receiving a pane;
an outer wall which is arranged substantially parallel to the glazing interior wall and connects the first and second side walls to one another directly or via connecting walls;
cavities which are enclosed by the first side wall and the second side wall, respectively, the glazing interior wall, the outer wall and the recess, or by the first side wall and the second side wall, respectively, the glazing interior wall, the outer wall, a first of the connecting walls and a second of the connecting walls, respectively, and the recess
wherein
the main body is designed as a hollow profile which is formed from the first plastics material and the second plastics material and which has an alternating arrangement of A segments and B segments, wherein an A segment is formed from the first plastics material and a B segment is formed from the second plastics material and the A and B segments each extend along a longitudinal direction of the spacer and abut one another in the longitudinal direction,
the outer wall comprises two first sections which each consist of a B segment and are arranged in the center between the first side wall and the second side wall, respectively, and the recess in a transverse direction of the spacer, which is perpendicular to the longitudinal direction of the spacer, and over the entire thickness of the outer wall in a vertical direction of the spacer, which is perpendicular to the longitudinal direction of the spacer,
the first side wall comprises a second section that consists of a B segment,
the second side wall comprises a third section that consists of a B segment, and
the second plastics material has a lower thermal conductivity than the first plastics material.

12. A method for producing a spacer according to claim 1, the method comprising:
providing a first nozzle for extrusion of the first plastics material;
providing a second nozzle for extrusion of the second plastics material; and
co-extruding the first plastics material and the second plastics material to form the main body in such a way that said main body is designed as the hollow profile which is formed from the first plastics material and the second plastics material and which has the alternating arrangement of A segments and B segments.

13. An insulated glass unit comprising a first pane a second pane, a spacer according to claim 1, which is arranged peripherally between the first pane and the second pane, wherein
the first pane is attached to the first side wall by a primary sealant,
the second pane is attached to the second side wall by a primary sealant,
the spacer separates an inner pane interspace from an outer pane interspace, and
a secondary sealant is arranged in the outer pane interspace.

14. A method for producing an insulated glass unit according to claim 13, the method comprising:
providing the spacer;
assembling the spacer to form a spacer frame;
providing the first pane and the second pane;
fastening the spacer between the first pane and the second pane by a primary sealant;
compressing a the pane arrangement composed of the first and second panes and the spacer; and
at least partially filling the outer pane interspace with a secondary sealant.

15. A method comprising providing the insulated glass unit according to claim 13 as building interior glazing, building exterior glazing and/or facade glazing.

16. A method for producing a spacer according to claim 11, the method comprising:
providing a first nozzle for extrusion of the first plastics material;
providing a second nozzle for extrusion of the second plastics material; and
co-extruding the first plastics material and the second plastics material to form the main body in such a way that said main body is designed as the hollow profile which is formed from the first plastics material and the second plastics material and which has the alternating arrangement of A segments and B segments.

17. An insulated glass unit, comprising a first pane, a second pane, a spacer according to claim 11, which is arranged peripherally between the first pane and the second pane, wherein
the first pane is attached to the first side wall by a primary sealant,
the second pane is attached to the second side wall by a primary sealant,
the spacer separates an inner pane interspace from an outer pane interspace, and
a secondary sealant is arranged in the outer pane interspace.

18. A method for producing an insulated glass unit according to claim 17, the method comprising:
providing the spacer;
assembling the spacer to form a spacer frame;
providing the first pane and the second pane;
fastening the spacer between the first pane and the second pane by a primary sealant;
compressing a pane arrangement composed of the first and second panes and the spacer; and
at least partially filling the outer pane interspace with a secondary sealant.

19. A method comprising providing the insulated glass unit according to claim 17 as building interior glazing, building exterior glazing and/or facade glazing.
